(19) United States
(12) Patent Application Publication
(10) Pub. No.: US 2005/0042057 A1
(43) Pub. Date: Feb. 24, 2005

(54) Connecting nut for screwing constructional elements to a platelike component

(76) Inventors: Gottfried Konig, Bad Laasphe (DE); Stephan Weitzel, Bad Laasphe (DE)

Correspondence Address: BANNER & WITCOFF, 1001 G STREET N W, SUITE 1100, WASHINGTON, DC, 20001, US

(21) Appl. No.: 10/497,036

(22) PCT Filed: Dec. 4, 2002
(86) PCT No.: PCT/EP02/13727

(30) Foreign Application Priority Data
Dec. 4, 2001 (DE) 10159380.5

(51) Int. Cl. F16B 39/00

(52) U.S. Cl. 411/103

(57) ABSTRACT

Connecting nut for screwing structural elements onto a panel-like component (5, 58), said connecting nut comprising a retaining element (2, 3; 56) in abutment with a nut part (1, 62) for attachment to the component. This is a two-part design with nut part (1, 62) and securing part (4, 53), said nut part (1, 62) and securing part (4, 53) enclosing the component (5, 58) between them, said securing part (4, 53) penetrating a through-hole (13, 14; 28, 29; 31; 32; 57) in the component (5, 58) with a snap-action hook (7, 8; 26, 27; 54) and being connectable to the nut part (1, 62). A receiving bore (11, 12; 59) in the retaining element (2, 3; 56) receives the snap-action hook (7, 8; 26, 27; 54), said snap-action hook (7, 8; 26, 27; 54) latching into the retaining element (2, 3; 56).

The invention relates to a connecting nut for screwing structural elements onto a panel-like component, said connecting nut comprising a retaining element, in abutment with a nut part, for attachment to the component.

Such a connecting nut is disclosed in EP 08 61 380 B1. Said connecting nut can be secured to a panel-like component in order to screw any kind of structural elements to the component by means of a screw. The screw is received by the nut part, which is connected to the component by retaining elements in abutment with said nut part. Said retaining elements consist of snap-action hooks, which extend through a through-hole in the component and latch thereinto, this attaching the plastic nut to the component.

A connecting nut for attachment to a panel-like component, said connecting nut likewise comprising a nut part and retaining elements in abutment therewith, is described in DE 44 12 431 C1. The nut part of said connecting nut serves to receive an adjusting nut, provided with a male thread, for adjusting a desired distance from the component, the adjusting nut being screwed with its male thread into the nut part depending on the length of the desired distance. The nut part has two snap-action hooks, which, by latching into the component, connect the nut part to the component.

The two above-indicated connecting nuts are of one-piece construction together with their retaining elements, the retaining elements in the form of snap-action hooks being available for the secure connection of the connecting nut to the panel-like component. Owing to its required spring characteristics, the respective plastic nut has a certain flexibility with respect to the component, something which is not always desired.

The object of the invention is to create a connecting nut of the initially indicated design, said connecting nut being attachable in simple manner to a panel-like component and exhibiting high stability with regard to the connection between its nut part and the component. The object of the invention is achieved by a two-part design with nut part and securing part, said nut part and securing part enclosing the component between them, said securing part penetrating through-holes in the component with snap-action hooks and being connectable to the nut part in that a receiving bore in the retaining element receives the snap-action hook, said snap-action hook latching into the retaining element.

In contrast, therefore, to the initially indicated prior art, which is based on a one-piece design of the connecting nut, the invention adopts a different approach according to which the connecting nut of the invention is of two-part design. By reason of this two-part design, it is possible to employ for the nut part from a wide range of materials that material which has especially advantageous characteristics firstly for the screwing in of self-cutting screws and secondly for the particular application in addition to being capable of applying the required holding forces. The securing part can then be produced from a material which guarantees the elasticity necessary for the snap-action hooks, for which, in this connection, a plastic material enters into consideration. Furthermore, plastic has the advantage that, in view of the design of the securing part with the snap-action hook, injection-moulding enters into consideration for an efficient manufacturing process. Of course, however, it is also possible, particularly if the snap-action hook is of corresponding length, for the securing part to be made from a metal of corresponding elasticity. Consequently, with regard to the manufacture of the connecting nut, there is a wide choice from among the available materials, this being of decisive importance for a low-cost manufacturing process. Furthermore, this choice with regard to the material to be used for the connecting nut makes it possible to adapt the material of the connecting nut to that of the panel-like component in the interests of an economical recycling process. Moreover, it should be pointed out that it is, of course, also possible to provide the nut part with an already cut or formed thread if the use of standard screws is desired. Owing to the division of the connecting nut into nut part with retaining element and securing part, there is also the essential advantage that all the constituent parts can be of relatively large design with regard to their contact area in relation to the panel-like component, with the result that the compressive load per unit area exerted by the nut part on the component can be kept small, something which is often of decisive importance for the attachment of such connecting nuts and the service life of the screwed connection.

The nut part may be provided with one single abutting retaining element and, consequently, the securing part may be provided with one single snap-action hook. It is, however, also possible and advantageous to provide the nut part with two oppositely positioned retaining elements and to provide the securing part with two snap-action hooks, said snap-action hooks being arranged on the securing part according to the positions of the retaining elements. This results in a symmetrical layout with regard to the supporting of the nut part in relation to the component, this ensuring that the nut part is uniformly held with respect to the component.

Advantageously, the securing part is in the form of a flange, said flange extending over the region of the retaining element and of the nut part and being provided with a through-hole aligning with the screw hole in the nut part. In order to screw on a structural element, a screw, gripping the structural element with its screw head, is introduced from the side of the securing part into the through-hole thereof and is screwed into the nut part until, as the screw is tightened, the nut part is pressed against the component and, consequently, the structural element, too, is pressed against the component, as a result of which the structural element is screwed to the component.

In order to ensure vibration-free seating of the plastic nut, particularly after preassembly thereof, the flange is advantageously provided with spring elements which press the flange against the component. In similar manner, the nut part with the retaining elements can also be provided with spring elements which press the nut part with the retaining element against the component. A further possibility for vibration-free attachment consists in providing the flange with a slight bulge in its longitudinal direction in order to preload the snap-action hook.

With regard to the attachment of the plastic nut on the component, it is often desired, for the purpose of compensating any manufacturing tolerance of the plastic nut, to provide an attachment region on the component in which the plastic nut is securely held. This is advantageously achieved in that the cross-section of the snap-action hook is provided with a considerable undersize in relation to the through-hole penetrated by the snap-action hook, with the result that the snap-action hook can be displaced in relation to the component, which means that, consequently, also the nut part is provided with a restricted region of attachment in relation to the component. This makes it possible to make allowance for any design inaccuracies or tolerances of further structural elements. The undersize of the snap-action hook with respect to the through-hole may be such that the latter is an oblong hole, as a result of which there is an undersize of the snap-action hook only in one direction (x direction) in which the plastic nut then permits a corresponding tolerance-compensating attachment. However, it is also possible for the undersize to extend radially around the snap-action hook, with the result that the undersize corresponds to a round through-hole, the tolerance-compensating attachment of the plastic nut extending in a plane in all directions (x-y direction).

In order, for the attachment of a structural element to the panel-like component, also to provide the possibility to make such attachment with a certain desired distance from the component, the plastic nut is advantageously of such design that the securing part comprises a sleeve axially with respect to the screw hole of the nut part, said sleeve projecting away from the flange and having a male thread onto which can be screwed a supporting nut in order to support a structural element which is to be secured by means of the plastic nut, said supporting nut being turned in order to adjust a desired distance from the component. In this case, a screw penetrating the nut part is able to draw the structural element to the component only to the extent allowed by the supporting nut, because the supporting nut can be screwed more or less far onto the sleeve, as a result of which the supporting nut ultimately forms the abutment when the structural element is being screwed on.

A variation on the provision of a supporting nut consists in that the securing part comprises a sleeve axially with respect to the screw hole of the nut part, said sleeve projecting away from the flange and containing an expandable tubular piece, said tubular piece projecting out of the sleeve and adjusting a distance from the component in order to support a structural element which is to be secured by means of the nut part, said distance being able to be fixed by screwing of a screw into the nut part and consequent expansion of the tubular piece in relation to the sleeve under friction locking. Similarly to the aforementioned supporting nut, this principle makes it possible to provide a supporting surface with which a certain distance can continuously be obtained for the attachment of a structural element.

So that the plastic nut attached to the component can again be removed in simple manner from the component, the securing part is provided with an unlocking hole in the region of the snap-action hook, an unlocking pin being insertable through the unlocking hole into the receiving bore in such a manner that a snap-action hook received by the receiving bore is unlocked. The unlocking pin then moves back the snap-action hook such that it releases the securing part, as a result of which the securing part can be pulled away from the component and therefore also from the retaining elements, with the consequence that the nut part is released.

When the snap-action hooks latch into the retaining elements, there may be play between the snap-action hooks and the retaining elements, this then resulting in a correspondingly loose connection between nut part with retaining element and the securing part. This may be desired in certain individual cases, particularly if, once again for purposes of the compensation of manufacturing tolerances, it is necessary for the connecting nut to be slid backwards and forwards in relation to the component prior to the final screwing on of a structural element (see below). Therefore, the two-part design of the connecting nut may be intentionally such that the snap-action hooks are provided with a play in their longitudinal direction in relation to the retaining elements. This also makes it possible to compensate any thickness tolerance of the panel-like component in the region of such play.

The plastic nut according to the invention additionally allows for the sealing of the plastic nut through-holes in the panel-like component, such that the nut part with the retaining element is provided with at least one continuous sealing lip. Correspondingly, the securing part can also be provided with at least one continuous sealing lip. This then ensures that water is unable to penetrate through the component at the location of the attached plastic nut, something which is of particular importance especially in automobile construction.

Example embodiments are presented in the drawings, in which:

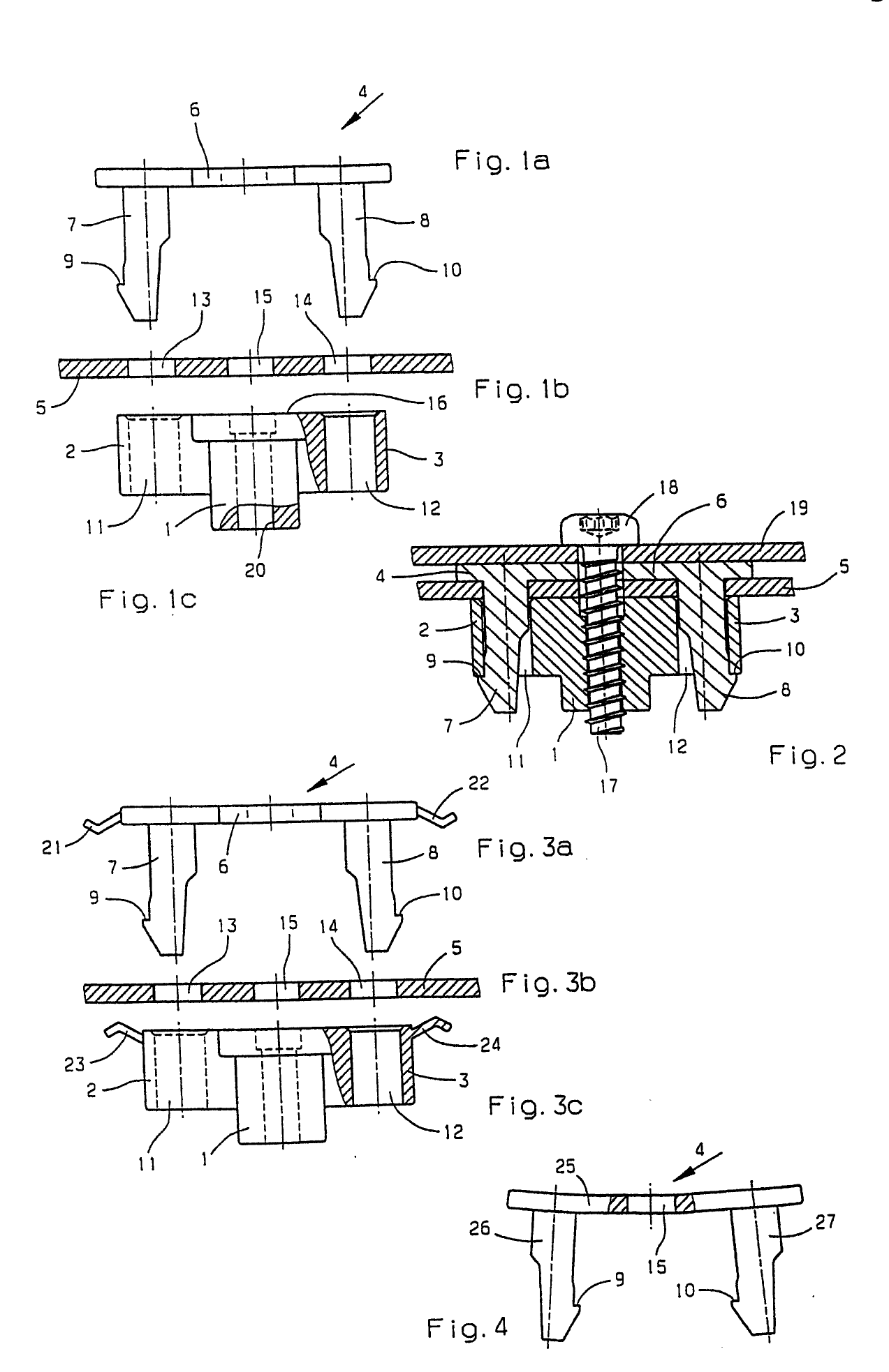

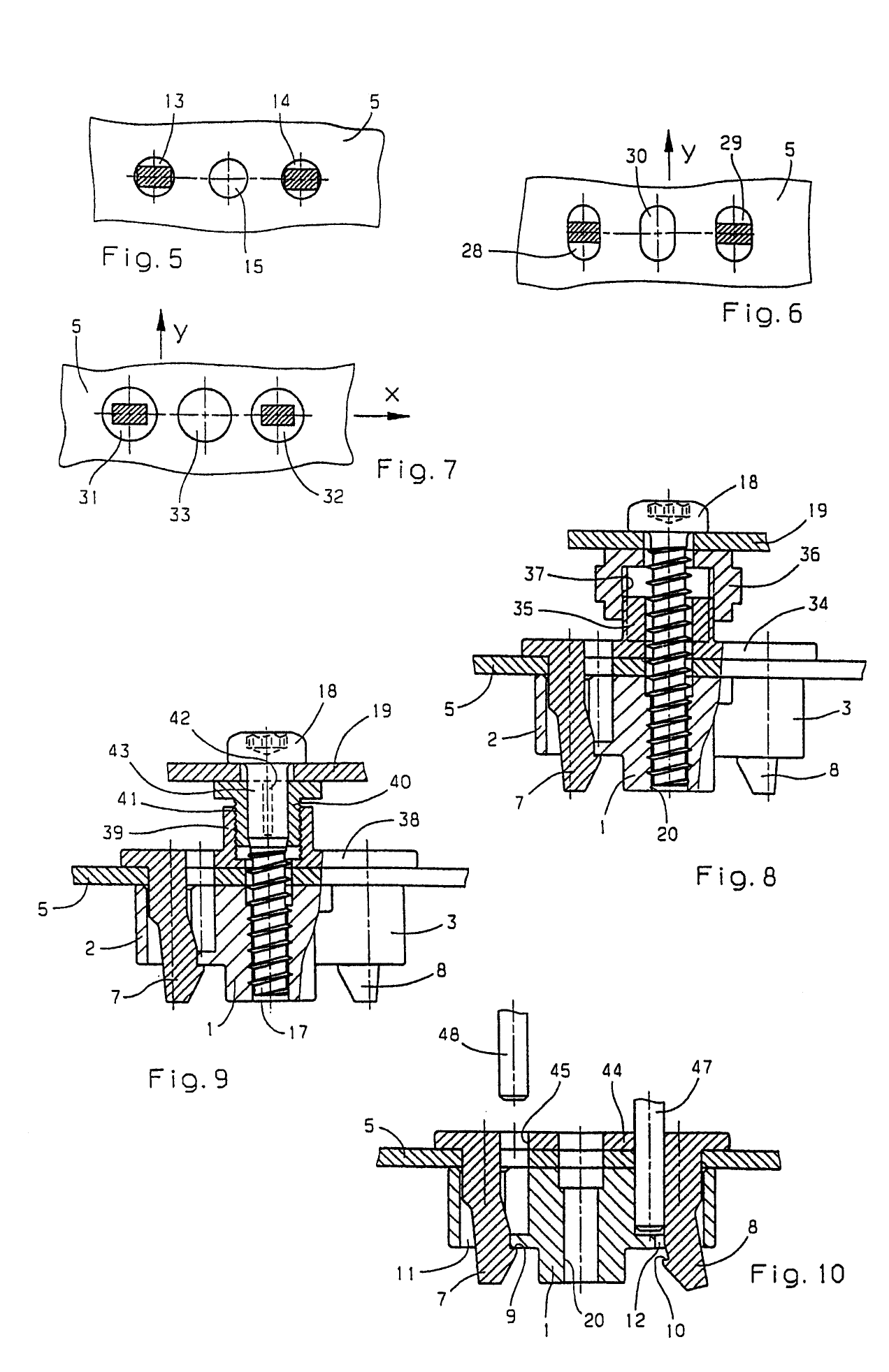

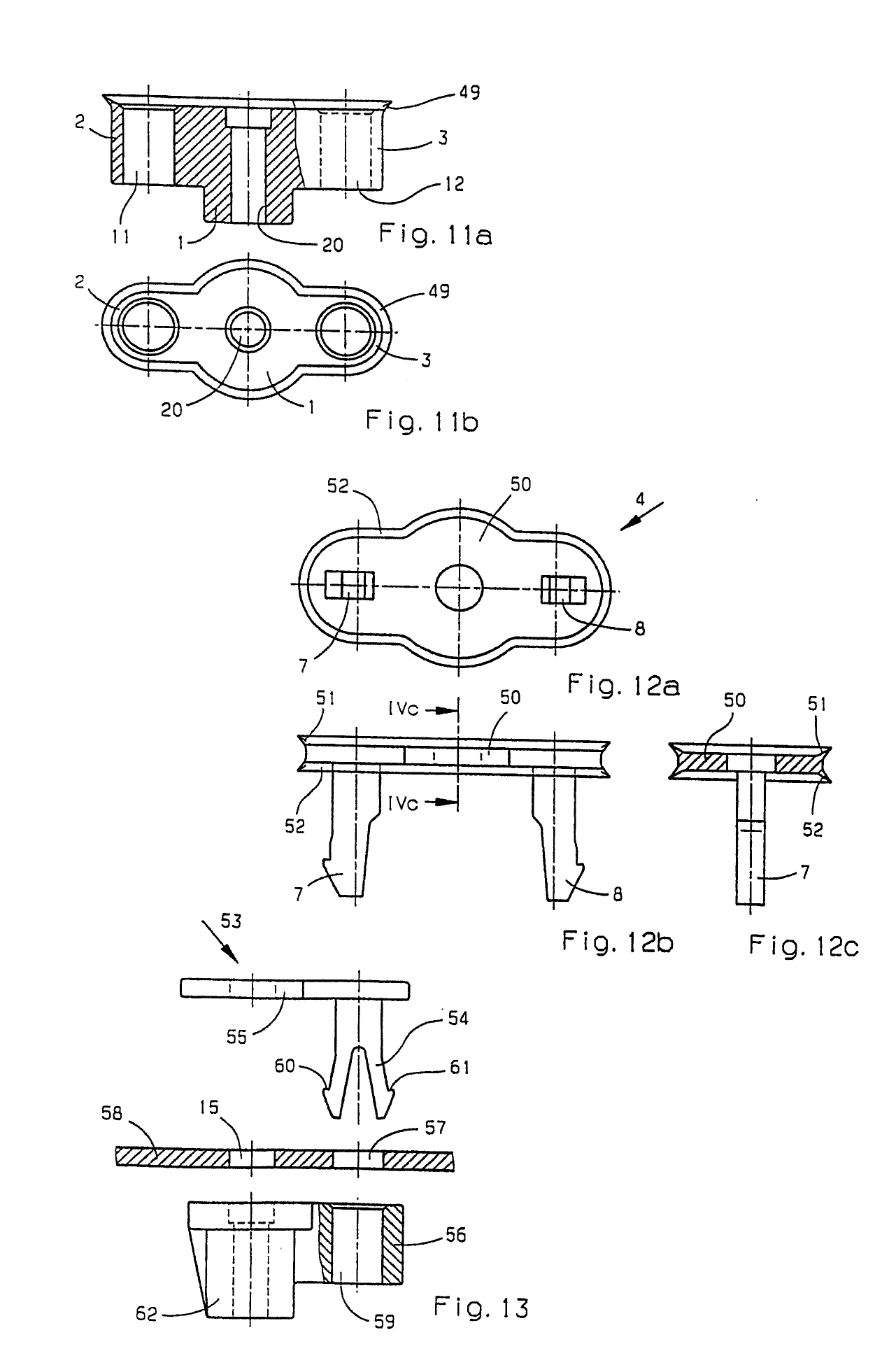

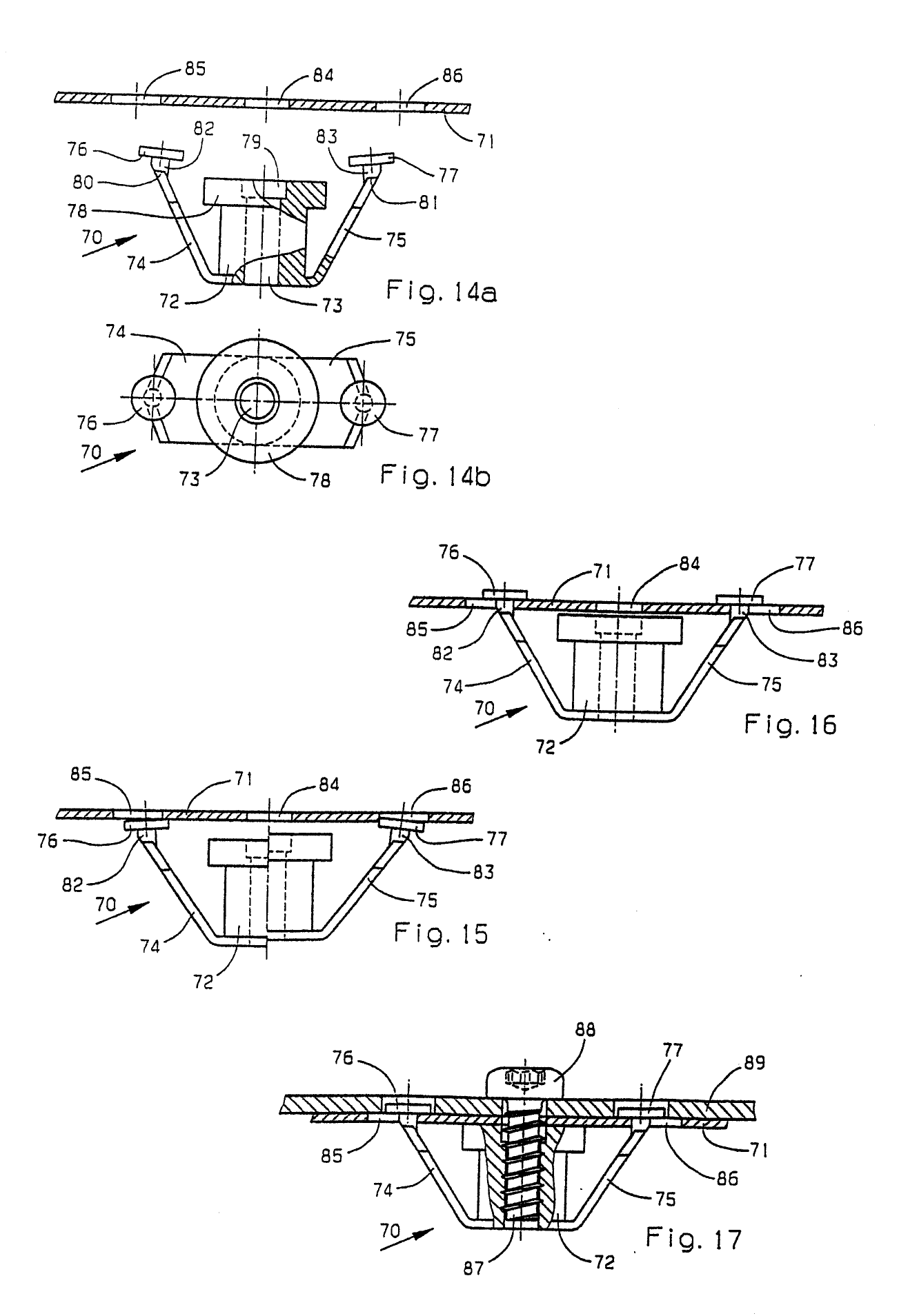

FIG. 1a-c show the connecting nut with an exploded view of its two individual parts, namely the securing part (FIG. 1a) and the nut part (FIG. 1c), the panel-like component (FIG. 1b) being shown situated therebetween;

FIG. 2 shows the assembled connecting nut, attached to the panel-like component with a screwed-in screw;

FIG. 3a-c show the same connecting nut with spring elements attached to the securing part and to the nut part for vibration-free preassembly;

FIG. 4 shows a bent retaining element likewise for vibration-free preassembly;

FIG. 5 shows a component with 3 circular penetrations into which the snap-action hooks just fit;

FIG. 6 shows a component with 3 oblong holes allowing the inserted snap-action hooks a play of the securing part in the longitudinal direction of the oblong holes;

FIG. 7 shows a component with 3 circular penetrations allowing the snap-action hooks a play in each direction;

FIG. 8 shows the design of the securing part with a sleeve for guaranteeing the distance between structural element and component;

FIG. 9 shows a different design of a sleeve for guaranteeing a distance;

FIG. 10 shows the design of the connecting nut such that it is possible for the snap-action hooks to be unlocked in relation to the nut part;

FIG. 11a+b show a design of the nut part with a sealing lip in a side view (FIG. 11a) and in the corresponding top view (FIG. 11b);

FIG. 12a-c show the embodiment of the securing part with a continuous sealing lip (FIG. 12a top view, FIG. 12b side view, FIG. 12c side view rotated through 90°);

FIG. 13 shows the design of a connecting nut with only one snap-action hook in a representation corresponding in principle to that of FIG. 1;

FIG. 14 shows a connecting nut with hooks attached to spring arms in side view (FIG. 14a) and in top view (14b);

FIG. 15 shows a connecting nut pressed onto the component, in two phases of the pressing-on operation;

FIG. 16 shows the connecting nut with hooks latched into the component;

FIG. 17 shows the latched-in connecting nut with a screw securing a structural element to the component.

FIGS. 1a, 1b, 1c show the connecting nut with its separately drawn constituent parts, namely the nut part 1 with the two retaining elements 2 and 3 as well as the securing part 4, the panel-like component 5 being shown between nut part 1 with the two retaining elements 2 and 3 and the securing part 4, the connecting nut composed of its two aforementioned constituent parts having to be attached to the panel-like component 5. The securing part 4 (see FIG. 12a for top view) comprises the flange 6 and the two snap-action hooks 7 and 8, which project away from said flange 6 and which are each provided with a shoulder 9 and 10, which shoulders 9 and 10 latch into the retaining elements 2 and 3 during assembly of securing part 4 and the retaining elements 2 and 3. The two constituent parts are joined together in that the securing part 4 with its two snap-action hooks 7 and 8 is introduced into the receiving bores 111 and 12 in the retaining elements 2 and 3, the latter assuming a position as described below with reference to FIG. 2. In the course of such joining together, the component 5 is pressed onto the nut part 1 with the two retaining elements 2 and 3, as a consequence of which the connecting nut, consisting of the two aforementioned constituent parts, is connected to the panel-like component 5. In order to permit such joining together, the component 5 contains the two penetrations 13 and 14, which are penetrated during assembly by the two snap-action hooks 7 and 8. The component 5 further contains the through-hole 15, which will be discussed in greater detail below.

FIG. 2 shows the assembled connecting nut attached to the component 5. The Fig. shows the two snap-action hooks 7 and 8, which with their shoulders 9 and 10 completely penetrate the receiving bores 11 and 12 and which with their shoulders 9 and 10 come behind the edges of the receiving bores 11 and 12, as a consequence of which the securing part, consisting of the flange 6 and the two snap-action hooks 7 and 8, is latched into the nut part 1 with the two retaining elements 2 and 3, the component 5 being held between the flange 6 and the surface 16 of the nut part 1 and the two retaining elements 2 and 3 (see FIG. 1c).

Screwed into the nut part 1 of the connecting nut is the screw 17, which with its head 18 presses a structural element 19 onto the flange 6, as a consequence of which the structural element 19 is screwed onto the component 5.

For this manner of screwing of the structural element 19 onto the connecting nut 1, 2, 3, 6, 7, 8 it is not necessary for the two retaining elements 2 and 3 to grip with zero play when the shoulders 9 and 10 latch into the retaining elements 2 and 3, i.e. during the joining together of securing part 4 and the retaining elements 2 and 3 there may initially very well be a certain play in the region of the shoulders 9 and 10. Despite this play, the connecting nut is captively attached to the component 5. When the screw 17 is then, as described above, screwed into the nut part 1, the screw head 18 draws the structural element 19 and the nut part 1 firmly together, with the result that the previously existing play in the region of the shoulders 9 and 10 is of no importance.

The example embodiment shown in FIGS. 1 and 2 comprises a securing part 4 and a nut part 1 with the two retaining elements 2 and 3, which are made of plastic and are preferably produced in the form of injection mouldings. On account of the material used, there is a certain bending elasticity between the two snap-action hooks 7 and 8 and the flange 6, with the result that, when the snap-action hooks 7 and 8 are introduced into the receiving bores 11 and 12, the snap-action hooks 7 and 8 are able to spring back slightly against a preload until, as described above, they then latch into the edges of the receiving bores 11 and 12 with their shoulders 9 and 10. Owing to the use of plastic for the nut part 1, it is readily possible for the screw 17 to be in the form of a self-cutting screw, i.e. the bore 20 (FIG. 1c) of the nut part 1 is given a cut thread as the screw 17 is screwed in, the screw 17 penetrating the aforementioned through-hole 15 (see FIG. 1b).

FIG. 3a, b, c show a design of the connecting nut with the two constituent parts securing part 4 and nut part 1 with the two retaining elements 2 and 3, which, apart from the below-described tolerance-compensating elements, are identical with the same constituent parts shown in FIGS. 1a and c.

In connection with FIG. 2, attention is drawn to the fact that the two constituent parts securing part 4 and nut part 1 with the two retaining elements 2 and 3 may be joined together with play, this being particularly desired if it is necessary to attach the connecting nut to components 5 of different thickness. In order in such a case to prevent a loose connection, the flange 6 and the retaining elements 2 and 3 are provided, as indicated in FIGS. 3a and c, with spring elements 21, 22 and 23, 24, which are of such design that they contact the component 5 with preload when the constituent parts of the connecting nut have been joined together. In the region of the flexibility of the spring elements 21 to 24 there is then a vibration-free connection between the constituent parts of the connecting nut shown in FIG. 3a-c and the component 5.

It should also be pointed out that it is, of course, also possible to provide only the spring elements 21 and 22 or the spring elements 23 and 24 if it is necessary to compensate only a relatively small play.

FIG. 4 shows a different type of tolerance compensation, tolerance compensation being achieved in this case in that the flange 25 of the securing part 4 is provided in its longitudinal direction with a slight bulge clearly visible in FIG. 4, as a result of which bulge, with the securing part 4 in the relaxed position, the snap-action hooks 26 and 27 stand slightly obliquely to the flange 25. When, after the two constituent parts of the connecting nut have been joined together, a screw is then screwed into the nut part as shown in FIG. 2, then the flange 25 is straightened under the effect of a structural element (structural element 19 in FIG. 2), as a consequence of which the two shoulders 9 and 10 are pressed towards each other and thereby come behind the edges of the two receiving bores (receiving bores 11 and 12 in FIGS. 1 and 2).

As is apparent from FIG. 2, the component 5 has three penetrations, namely the two penetrations 13 and 14 for receiving the snap-action hooks 7 and 8 and the through-hole 15. If the said penetrations are of such a size that the parts which pass through them, namely snap-action hooks 7 and 8 and the screw 17, just fit, as shown in FIG. 5, then, when securing part 4, component 5 and nut part 1 with the two retaining elements 2 and 3 are joined together, there results in the plane of the component 5 a zero-play position of the connecting nut in relation to the component 5. If, however, it is desired that there should be play between the connecting nut and the component 5, then the component 5 can be of the design shown in FIG. 6, namely with penetrations 28, 29 and 30 in the form of oblong holes. Such a design results in a longitudinal play of the component 5 (y direction). Conversely, if the penetrations 31, 32 and 33 are in the form of relatively large round holes, as shown in FIG. 7, then there is play in all directions (x-y direction). Therefore, in the example embodiments shown in FIG. 6 and FIG. 7, there is an undersize of the snap-action hooks in relation to the corresponding penetrations.

FIG. 8 shows an example embodiment which makes it possible for a structural element 19 to be attached at a desired certain distance from the component 5. For this purpose, the flange 34 of the securing part with the two snap-action hooks 7 and 8 comprises the sleeve 35, which projects away from the flange 34 and axially with respect to the bore 20, the bore 20 forming the screw hole in the nut part 1. The sleeve 35 is provided with a male thread onto which is screwed the supporting nut 36, which, for this purpose, is provided with the female thread 37. Depending on how far the supporting nut 36 has been screwed onto the sleeve 35, there is a defined distance between the end face of the supporting nut 36 facing the screw head 18 and the side of the component 5 facing the screw head 18, said defined distance being adjustable at will by screwing the supporting nut 36 over the region of the male thread of the sleeve 35. With regard to the further individual parts of the connecting nut shown in FIG. 8, reference is made to the explanatory remarks in relation to FIGS. 1 and 2.

FIG. 9 shows a different manner of adjusting a certain distance between the structural element 19 and the component 5. The flange 38 of the securing part is once again provided with a sleeve 39 which projects axially away from the flange 38 as shown in the example embodiment in FIG. 8, but which comprises the tubular piece 40, which fits snugly into the sleeve 39. In FIG. 9 this fit is shown as a kind of roughening of the corresponding surfaces in order to provide the two components, namely the sleeve 39 and the tubular piece 40, with a certain mutual support in the sense of friction locking. The tubular piece 40 has a plurality of axial longitudinal slits 42, which enable the tubular piece 40 to expand. In order to establish the aforementioned certain distance between the structural element 19 and the component 5, the tubular piece 40 is inserted into the sleeve 39 until the end face of the tubular piece 40 facing the screw head 18 has reached the desired position. Next, the screw 17 is screwed into the nut part 1, a cylindrical region 43 of the screw 17 being forced into the tubular piece 40 and correspondingly expanding the tubular piece 40. On account of this expansion, made possible by the slits 42, the tubular piece is pressed against the inner wall of the sleeve 39 and is thus firmly held in relation to the sleeve 39 by friction locking.

FIG. 10 shows a connecting nut in which the snap-action hooks 7 and 8 and the securing part can be unlocked. For this purpose, the flange 44 of the securing part is provided with unlocking holes, of which only the unlocking hole 45 is directly visible and identified. Situated in a further unlocking hole is the unlocking pin 47, which serves to unlock the snap-action hook 8. The unlocking pin 48 is provided for the unlocking of the snap-action hook 7, but is drawn at a distance from the flange 44 so that the unlocking hole 45 is made visible by this manner of drawing. The receiving bores for the snap-action hooks 7 and 8 in the flange 44 (see FIG. 1c) have been suitably widened for additionally receiving the unlocking pins 47 and 48. As a result of the introduction of the unlocking pins 44 and 48, the two snap-action hooks 7 and 8 are pressed back against their preload and therefore with their shoulders 9 and 10 (see FIG. 1) release the nut part 1, as shown by the snap-action hook 8.

By means of the above-described connecting nut it is also possible to seal the penetrations 13, 14 and 15 in the component 5. This is accomplished in that the nut part 1 with the retaining elements 2 and 3 is provided with a sealing lip. In FIG. 11a (side view) this is the sealing lip 49, which surrounds the edge of the nut part 1 with the two retaining elements 2 and 3 and which consists of a flexible resilient plastic. The nut part 1 with the two retaining elements 2 and 3 then presses with the sealing lip 49 against a component, which is not shown in FIG. 11a, the component possibly being, for example, the component 5 from FIGS. 1 and 2.

According to FIG. 12a, b and c, also the securing part 4 is provided with such a continuous sealing lip on both sides of the flange 50. These are the sealing lips 51 and 52, which, when the constituent parts of the connecting nut are joined together and the connecting nut is attached to a component, press on the one hand against a structural element to be attached (19 in FIG. 2) and on the other hand against a component (5 in FIG. 2) to which the connecting nut has been attached. Owing to the said sealing lips, it is also possible to seal from each other the spaces separated by the structural element to be attached. It should also be pointed out that it may, of course, also be sufficient to provide the sealing lip on only one of the two constituent parts of the connecting nut if an especially high-quality seal is not required.

Similarly to FIG. 1, FIG. 13 shows a connecting nut in which the securing part 53 is provided with only one snap-action hook 54, which is in abutment with the flange 55 of the securing part 53.

The snap-action hook 54 penetrates the penetration 57 in the component 58 when securing part 53 and retaining element 56 are joined together. In order to ensure that the snap-action hook 54 finds sufficient support in the receiving bore 59 and its edge, the snap-action hook 54 is provided with two lugs which, with their shoulders 60 and 61, come behind the corresponding edge of the receiving bore 59. Also with such a design of a connecting nut it is possible for a structural element to be attached to the component 58 according to the method of securing shown in FIGS. 1 and 2, this being accomplished with a screw which penetrates the flange 55 and the component 58 and enters into the nut part 62.

Described in the following is a further embodiment of a connecting nut which makes use of the principles employed in the previously described connecting nut. This further embodiment is a connecting nut for screwing structural elements onto a panel-like component with a through-hole for a screw to be screwed into a nut part of the connecting nut and with two receiving holes for hooks provided on the connecting nut. The purpose of said connecting nut is as already described above, i.e. it can be attached in simple manner to a panel-like component and is characterized by high stability with regard to the connection between its nut part and the component. This is accomplished in that the hooks are connected to the nut part by spring arms extending substantially longitudinally to the component in such a manner that, for preassembly of the connecting nut on the component, the nut part is pressed onto the component and, consequently, through expansion of the spring arms the latter are guided into the receiving bores and latch inwardly therein.

The above-mentioned further embodiment is shown in FIG. 14 to 17.

FIGS. 14a and b show the connecting nut 70 separated from the panel-like component 71, FIG. 14a showing a side view of the connecting nut 70 with the component 71 and FIG. 14b showing the connecting nut 70 alone in a top view. The connecting nut 70 comprises the nut part 72, in which is provided the through-hole 73 for receiving the screw 87 shown in FIG. 17. Attached to the nut part 72 are the spring arms 74, 75, which terminate in hooks 76, 77. The connecting nut 70 consists of a plastic, which provides the spring arms 74, 75 with the elasticity required for the operation of attaching the connecting nut 70 to the component 71. According to the example embodiment shown in FIGS. 14a and b, the spring arms 74 and 75 are moulded onto one side of the nut part 72. In order to obtain an advantageous contact of the nut part 72 with the component 71, the nut part 72 is provided with the collar 78, which, with its end face facing the component 71, provides a suitably large contact surface in relation to the component 71. For the purpose of facilitating the introduction of a screw into the through-hole 73, said through-hole 73 is provided in the region of the collar 78 with the widening 79. The spring arms 74, 75 are in the form of plastic strips projecting away from the nut part 72, said plastic strips transitioning at their ends 80, 81 into round extensions 82, 83 with which the hooks 76, 77 are in abutment.

The component 71 in this case forms a panel containing the through-hole 84 for receiving the screw 87 and the through-holes 85, 86 for receiving the hooks 76, 77.

FIG. 15 shows the operation of attaching the connecting nut 70 to the component 71 in two phases, this being accomplished by the split drawing of the nut part 72, the left-hand part showing the position of the spring arm 74 when lightly pressed onto the component 71 and the right-hand part showing the pressing-on operation with the spring arm 75 in a position in which the hook 77 has been guided into the through-hole 86.

As the nut part 72 is further pressed onto the component 71, the two hooks 76, 77 finally slide through the through-holes 85, 86. In this position, the spring arms 74, 75 snap back, the hooks 76, 77 latching into the component 71, as clearly shown in FIG. 16. Thus, the connecting nut 70 has been preassembled on the component 71. The collar 78 may already contact the component 71; alternatively, however, it may also be at a small distance from the component 71, as shown in FIG. 16. With the connecting nut with nut part 72 and component 71 in the position shown in FIG. 16, a screw 87 can then be screwed into the nut part 72.

FIG. 17 shows the connecting nut 70 with screwed-in screw 87, the screw head 88 of the screw 87 securing a structural element 89 to the component 71. Consequently, the nut part 72 receiving the screw 87 ensures, consistently with its function as the connecting nut 70, that the structural element 89 is securely screwed to the component 71, the preassembled connecting nut 70 guaranteeing the simple attachment of the structural element 89 to the component 71.

1. Connecting nut for screwing structural elements onto a panel-like component (5, 58), said connecting nut comprising a retaining element (2, 3; 56) in abutment with a nut part (1, 62) for attachment to the component, characterized by a two-part design with nut part (1, 62) and securing part (4, 53), said nut part (1, 62) and securing part (4, 53) enclosing the component (5, 58) between them, said securing part (4, 53) penetrating through-holes (13, 14; 28, 29; 31; 32; 57) in the component (5, 58) with snap-action hooks (7, 8; 26, 27; 54) and being connectable to the nut part (1, 62) in that a receiving bore (11, 12; 59) in the retaining element (2, 3; 56) receives the snap-action hook (7, 8; 26, 27; 54), said snap-action hook (7, 8; 26, 27; 54) latching into the retaining element (2, 3; 56).

2. Connecting nut according to claim 1, characterized in that said connecting nut is provided with two retaining elements (2, 3) oppositely positioned with respect to the nut part (1) and the securing part (4) is provided with two snap-action hooks (7, 8), said snap-action hooks (7, 8) being arranged on the securing part (4) according to the positions of the retaining elements (2, 3).

3. Connecting nut according to claim 1, characterized in that the securing part (4) is in the form of a flange (6), said flange (6) extending over the region of the retaining element(s) (2, 3) and of the nut part (1) and being provided with a through-hole (15) aligning with the screw hole (20) on the nut part (1).

4. Connecting nut according to claim 1, characterized in that the snap-action hook(s) (7, 8; 26, 27; 54) latch into the retaining element(s) (2, 3; 56) with longitudinal play.

5. Connecting nut according to claim 3, characterized in that the flange (6) presses against the component (5) with spring elements (21, 22).

6. Connecting nut according to claim 4, characterized in that the nut part (1) with the retaining element (2, 3) presses against the component with spring elements (23, 24).

7. Connecting nut according to claim 3, characterized in that, in order to preload the snap-action hook (26, 27), the flange (25) is provided with a slight bulge in its longitudinal direction.

8. Connecting nut according to claim 1, characterized by a tolerance-compensating attachment to the component (5) through a cross-section of the snap-action hook (7, 8) in the region of the component (5) of considerable undersize in relation to the through-hole penetrated by the snap-action hook (7, 8).

9. Connecting nut according to claim 8, characterized in that the undersize extends in a direction according to an oblong hole (y direction) (28, 29) in the component (5).

10. Connecting nut according to claim 8, characterized in that the undersize extends radially around the snap-action hook according to a round through-hole (x-y direction) (31, 32).

11. Connecting nut according to claim 1, characterized in that the securing part comprises a sleeve (35) axially with respect to the screw hole (20) of the nut part (1), said sleeve (35) projecting away from the flange (34) and having a male thread onto which can be screwed a supporting nut (36) in order to support a structural element (19) which is to be secured by means of the connecting nut, said supporting nut (36) being turned in order to adjust a desired distance from the component (5).

12. Connecting nut according to claim 1, characterized in that the securing part comprises a sleeve (39) axially with respect to the screw hole (20) of the nut part (1), said sleeve (39) projecting away from the flange (38) and containing an expandable tubular piece (40), said tubular piece (40) projecting out of the sleeve (39) and adjusting a distance from the component (5) in order to support a structural element (19) which is to be secured by means of the nut part (1), said distance being able to be fixed by screwing of a screw (17) into the nut part (1) and consequent expansion of the tubular piece (40) in relation to the sleeve (39) under friction locking.

13. Connecting nut according to claim 1, characterized in that the securing part comprises an unlocking hole (45) in the region of the snap-action hook (7, 8) an unlocking pin (47, 48) being insertable through the unlocking hole (45) into the receiving bore (11, 12) in such a manner that a snap-action hook (7, 8) received by the receiving bore (11, 12) is unlocked.

14. Connecting nut according to claim 1, characterized in that the nut part (1) with the retaining element (2, 3) is provided with at least one continuous sealing lip (49).

15. Connecting nut according to claim 1, characterized in that the securing part (4) is provided with at least one continuous sealing lip (51, 52).

16. Connecting nut (70) for screwing structural elements onto a panel-like component (71) with a through-hole (84) for a screw (87) to be screwed into a nut part (72) of the connecting nut (70) and with two receiving bores (85, 86) for hooks (76, 77) attached to the connecting nut (70), characterized in that the hooks (76, 77) are connected to the nut part (72) by spring arms (74, 75) extending substantially longitudinally to the component (71) in such a manner that, for preassembly of the connecting nut (70) on the component (71), the nut part (72) is pressed onto the component (71) and, consequently, through expansion of the spring arms (74, 75) the latter are guided into the receiving bores (85, 86) and latch inwardly therein.
